(19) United States
(12) Patent Application Publication
(10) Pub. No.: US 2010/0031403 A1
(43) Pub. Date: Feb. 4, 2010

(54) Heat Coupling Device

(75) Inventors: Mirko Leuschner, Dresden (DE); Jens Struckmeier, Dresden (DE); Ulrich Geisler, Freital (DE); Torsten Jahnke, Lychen (DE)

Correspondence Address: FROST BROWN TODD, LLC, 2200 PNC CENTER, 201 E. FIFTH STREET, CINCINNATI, OH, 45202, US

(73) Assignee: Nambition GmbH, Dresden (DE)

(21) Appl. No.: 12/376,160

(22) PCT Filed: Aug. 11, 2006
(86) PCT No.: PCT/EP2006/007976

§ 371 Date: Sep. 16, 2009

(51) Int. Cl. G01Q 60/24

(52) U.S. Cl. 850/13; 977/742

(57) ABSTRACT

The invention concerns a heat coupling device for scanning force or atomic force microscopy, comprising a first heat conducting device (27), a second heat conducting device (28) and a coupling device (36, 38, 39, 40, 41), in which the first heat conducting device (27) is movable relative to the second heat conducting device (28) and the coupling device (36, 38, 39, 40, 41) is arranged between the first and second heat conducting device (27, 28) and designed so that it is at least partially deformable fluid-like and/or flexible and the heat can be transferred between the first and second heat conducting device (28).

The present invention generally concerns devices and methods for investigation of biological systems as well as solid systems and especially those that permit scanning probe microscopic and atomic force microscopic investigations.

### BACKGROUND OF THE INVENTION

Biological systems and processes occurring in them are based on molecular interactions. Molecular forces in biological systems differ from other molecular systems, especially with respect to chemical reactions and physical changes of an overall system. Assertions concerning molecular interactions in biological systems, however, represent the prerequisite in order to analyze such systems and make further assertions.

Scanning probe microscopic methods, like scanning force microscopy (SFM) or atomic force microscopy (AFM), are used among other things for measurement of molecular interactions in biological systems.

The scanning force microscopic methods make it possible to determine surface topographies with high lateral and vertical resolution. Lateral resolution is understood here to mean resolution in a plane of a surface of a biological system being investigated, whereas the resolution perpendicular to this plane is referred to as vertical resolution.

Atomic force and scanning force microscopic methods are also used for measurement of molecular interactions in biological systems. These include force microscopic approaches like scanning force microscopy (SFM) or atomic force microscopy (AFM).

With such scanning force microscopic approaches, in addition to the topology of the surface of a biological sample, its elasticity or adhesion and friction forces acting there can be recorded. Scanning force microscopy, in this case ordinarily referred to as force microscopy, determines molecular forces of a sample by means of a probe with which the sample is scanned in order to quantitatively characterize interactions between individual molecules. The probe ordinarily includes a tip fastened to a freely supported extension or measurement beam, also referred to as cantilever. To investigate the sample the probe is scanned over the surface of the sample, during which the lateral and vertical positions and/or deflections of the probe are recorded. Movements of the probe relative to the sample are possible based on the elastic properties of the probe and especially the cantilever. Based on recorded lateral and vertical positions and/or deflections of the sample, molecular forces of the sample and from them its surface topography are determined.

Movements of the sample are usually determined by means of optical measurement devices, which have resolutions in the range of 0.1 nm and permit detection of forces of a few pN.

In order to determine the surface topography of the biological sample, the surfaces of the sample and the probe of a force microscope are brought into contact with each other so that a force acting between them is established at a predetermined value (for example, 50-100 pN). The sample and probe are then moved laterally relative to each other so that scanning of the surface sample by the probe occurs. The sample and/or probe are then also moved vertically in order to keep the force acting between the sample and the probe at a stipulated value. Movements of the sample and probe relative to each other can be produced by a corresponding arrangement, which includes a piezoceramic, for example.

Scanning force microscopy permits investigation of biological samples in buffer solutions at physiologically relevant temperatures (for example, between 4 and 60° C.). For this purpose it is necessary that the sample be heated or cooled to a specified temperature and kept at this temperature. Control of the temperature for materials science is also important for investigation of phase transitions, for example, those that occur during crystal growth. Temperature also plays an interesting role for processes investigated in biosciences. For example, the rate of physiological processes, the structure of biological molecules and molecular bonds can be controlled via the temperature.

Different heating and/or cooling devices for scanning force microscopy are known in the prior art.

Liquid samples are heated, for example, in a liquid cell. A known liquid cell is the “bioheater” of Asylum Research. The liquid cell permits heating of a liquid sample to 80° C. The “polyheater” of the same company permits heating of solid samples to a temperature of 300° C. These heating systems are arranged directly on a positioning device (scanner). The positioning device itself can be moved by a corresponding arrangement, for example, via piezoactuators. Cooling, however, is not possible with these two heating systems.

Another heating device for scanning force microscopy is disclosed in U.S. Pat. No. 5,821,545. This heating device is characterized by the fact that the heating element, which is supposed to heat the sample, is mounted on a sample carrier, which is situated on a ceramic tube for heat insulation. Thermal stability of the sample with the sample carrier is therefore ensured and undesired heating of other parts of the microscope is prevented.

A heating/cooling system (Peltier element) is known from U.S. Pat. No. 5,654,546, which is arranged beneath a sample carrier. A pipeline system is again situated beneath the Peltier element, through which, for example, water can be passed in order to cool the Peltier element. The sample carrier with the Peltier element and the pipeline system are situated on a positioning device.

As stated above, there is a demand for flexible temperature control in scanning force microscopy. There is a particular demand for systems that can both heat and cool. This can be achieved, for example, by means of a Peltier element. If a sample is cooled with a Peltier element, the corresponding opposite side of the Peltier element is heated. This heat should be taken off, since otherwise undesired strong temperature gradients can develop on the microscope structure. As stated above, in the prior art the heat is taken off by means of a water-cooling system in which water is passed through pipeline systems situated beneath the Peltier element. In order for the heat to be taken off accordingly it is necessary in the prior art to pass the water (or another heat transfer medium) through the pipeline system. A pump device is generally present for this purpose, which causes water transport by movement of mechanical parts. This mechanical movement of the pump (like oscillations, vibrations) and movements that are caused by transport of water, like pressure differences, can be transferred to the pipeline system and therefore to the Peltier element, the sample carrier, the sample and consequently the positioning unit. Since scanning force microscopy requires positioning in the nanometer range, such transferred movements have a negative effect on the resolution or cause other disturbances, like positioning errors or disturbances in recording of power cures during which bonding forces of molecules are measured, etc.

The task of the present invention is to provide a device that permits both heat transport and at the same time at least reduces transfer of mechanical movements (oscillations, vibrations).

### SUMMARY OF THE INVENTION

According to a first aspect the present invention provides a heat coupling device for scanning force or atomic force microscopy with: a first heat conducting device, a second heat conducting device and a coupling device, the first heat conducting device being movable relative to the second heat conducting device and the coupling device being arranged between the first and second heat conducting device and designed so that it is at least partially deformable fluid-like and/or flexible and can transfer heat between the first and heat conducting device.

Another aspect of the invention concerns the use of such a heat coupling device for a scanning force or atomic force microscope or the like. Additional aspects and features of the invention are apparent from the dependent claims, the following description, practical examples and the accompanying drawings.

### BRIEF DESCRIPTION OF THE DRAWINGS

Variants of the invention are now described as examples with reference to the enclosed drawings in which:

FIG. 1 shows a schematic sectional view according to a first practical example of the present invention, which runs along the cutting axis depicted in FIG. 2;

FIG. 2 shows a schematic top view according to the first practical example depicted in FIG. 1;

FIG. 3 shows a schematic sectional view according to a second practical example of the present invention;

FIG. 4 shows a schematic sectional view according to a third practical example of the present invention;

FIG. 5 shows a schematic sectional view according to a fourth practical example of the present invention.

### DESCRIPTION OF PREFERRED PRACTICAL EXAMPLES

FIG. 1 shows in detail a heat coupling device according to a first practical example in a sectional view through the device. The same reference numbers in the figures denote the same parts in the practical examples. General explanations concerning the practical example initially follow from a detailed description of FIG. 1.

In scanning force microscopy and atomic force microscopy a sample is scanned by means of a probe in a specified grid. In this case either the probe can be moved in well-defined steps over the sample or the probe is fixed and the sample is moved, for example, by means of a sample carrier with positioning unit. In some practical examples both the probe and sample carrier are positioned. Deflections of the probe (for example, measured tunnel currents, depending on the microscopy method) are converted by imaging methods to a visible, magnified image of the sample or the deflections of the probe are plotted as a force-distance curve or interaction-distance curve. In the practical examples in which the sample being investigated is moved, the sample is arranged on a sample carrier, which is moved by means of a positioning unit in the x, y, z direction. This arrangement is also called a scanner. The scanner in the practical examples includes actuators, like piezoactuators, which are suitable for executing the necessary movements in the nanometer range.

As stated above, it is necessary for certain investigations (phase transitions, bonding energies, reaction rates) of samples to bring the sample to a certain temperature and keep it at that temperature. For this purpose, in the practical examples elements are used that can both heat and cool. Peltier elements are suitable, which, depending on the direction of flow, can both heat and cool on one side. The heating/cooling element in principle can be arranged on any location of the scanning force microscope. For example, the heating/cooling elements can be arranged in the vicinity of the probe in order to heat it or cool it. In some practical examples at least one heating/cooling element is situated as close as possible to the sample, for example, beneath the sample. It is possible to directly heat the sample and cool it on this account, depending on the requirements. In some practical examples upper temperatures of 300° C. and lower temperatures of about −15° C. are reached. The attained temperatures depend on dimensioning of the heating/cooling element and in some practical examples therefore lie well above or below the stated values. Several heating/cooling elements can also be combined into a larger heating/cooling module in order to reach higher or lower temperatures.

When the heating/cooling element is in operation, it is desirable that the developing heat only reach the sites of the entire apparatus, i.e., the scanning force microscope, at which they are required. This means that in some practical examples the heat developing during operation of a heating/cooling element is taken off, whereas in other examples the heat is supplied to an element (for example, the sample).

To divert (or supply) heat a heat coupling device is used in the practical examples. The heat coupling device includes in some practical examples a first and second heat conducting device and a coupling device arranged in between.

The first heat conducting device conducts the heat from the heating/cooling element and/or the sample carrier or another element of the scanning force microscope in the direction of the coupling device, whereas the coupling device conveys the heat to the second heat conducting device. In principle, the process can also be reversed. Heat transport in one direction is always described below for simplification.

In some practical examples the first heat conducting device is arranged beneath the heating/cooling element, the coupling device beneath it and the second heat conducting device beneath it. In other practical examples, on the other hand, the first heat conducting device is arranged next to the heating/cooling element. In still other practical examples the first conducting device is arranged above the heating/cooling element.

The coupling device between the first and second heat conducting device is designed so that it can transfer heat. In some practical examples the coupling device includes a gap between the first and the second heat conducting device, which is filled with a corresponding coupling agent, like a fluid (for example, liquid metal), a sponge structure, a mesh, a brush structure, an individual wire or several wires that are flexible, or their combination. A gap filled with the coupling agent in some practical examples is a few millimeters or micrometers so that movement of the first heat conducting device relative to the second heat conducting device is guaranteed. In some practical examples the coupling device includes compressible and/or incompressible components. In still other practical examples the coupling device includes rigid and/or non-rigid components. In some practical examples combinations of rigid, non-rigid, compressible and incompressible components are present in the coupling device.

In the practical examples in which the sample carrier is moved relative to the probe, movement of the sample carrier of, say, 100 micrometers in the x-y direction (laterally) and 20 micrometers in the z direction (vertically) is possible. In some practical examples the sample carrier is connected to the first heat conducting device (for example, indirectly via a heating/cooling element) so that movement of the sample carrier is transferred to the first heat conducting device. In some practical examples the first heat conducting device even includes the sample carrier and/or at least one heating/cooling element.

Returning to the coupling device, in some practical examples this consequently fulfills two tasks. In the first place, it transfers heat from the first heat conducting device to the second one (or/and vice-versa) and additionally permits movement of the first heat conducting device relative to the second one. In some practical examples the coupling device even fulfills the objective of at least partially attenuating mechanical vibrations that act on the second heat conducting device. The coupling device therefore permits heat transfer with at least partially simultaneous mechanical decoupling. Mechanical decoupling here means a decoupling that at least moderates and/or in some cases even completely prevents the transfer of mechanical movements, like oscillations, vibrations, etc. from a first to a second heat conducting device (or vice-versa). For example, this is achieved by the viscosity of a fluid arranged between the first and second heat conducting device, which makes sure that possible oscillations are broken down or attenuated accordingly.

In addition, the first and/or second heat conducting device should have a structure that serves to enlarge the surface that engages in the coupling agent (here the fluid). Because of this the heat transfer rate is increased. In addition, in some practical examples the coupling device includes a discharge reservoir for the fluid in order to permit movements of the first heat conducting device relative to the second heat conducting device in the z direction. If the fluid were absolutely tightly arranged between the two heat conducting devices, movement in the z direction might be prevented or at least hampered by the fluid because of incompressibility inherent to most fluids. This is prevented in some practical examples by a corresponding fluid reservoir, in that fluid exchange with the reservoir occurs during movement in the z direction. Because of this, during movement of the two heat conducting devices, which leads to an increase in the gap between the devices, fluid is fed from the reservoir into the gap. On the other hand, during a corresponding movement that reduces the gap, fluid flows from the gap into the reservoir.

This damping of movements (oscillations, vibrations) of the second heat conducting device relative to the first heat conducting device with simultaneous heat transfer is achieved in different ways in some practical examples.

In some practical examples the coupling device includes a brush structure that is immersed in a corresponding heat conducting agent (for example, fluid). The brush structure is arranged beneath the first heat conducting element and engages in a corresponding reservoir arranged in the second heat conducting device, which is filled with a fluid. Heat taken off by the first heat conducting device is transferred in this practical example to the brush structure and this gives off the heat to the surrounding fluid and the fluid then conveys the heat to the second heat conducting device. The brush structure can be produced, for example, from metal or a metal alloy. By arranging the brush structure in the fluid both heat transfer and movement of the brush structure in the fluid and therefore movement of the first heat conducting device relative to the second heat conducting device in any spatial direction are guaranteed. Any type of movement (oscillation, vibrations, etc.) that has transferred to the second heat conducting device and therefore also to the fluid is hardly transmitted at all to the brush structure, since the friction between the brush structure and the fluid is relatively limited and consequently negligible. Positioning movements of the first heat conducting device, which are the result of positioning of the sample carrier connected to it, are transferred directly to the brush structure, which in some practical examples is arranged directly on the first heat conducting device. Since the reservoir with the fluid and the brush structure are dimensioned accordingly, the brush structure can follow the positioning movement of the first heat conducting device. The positioning movement in the z direction is also possible, since in some practical examples the bristles of the brush structure are long enough that they are still sufficiently immersed in the fluid, despite movement in the z direction, in order to guarantee heat transfer.

In other practical examples the coupling device includes a sponge structure consisting of a heat conducting material. The sponge structure is arranged between the first and second heat conducting device and is in surface contact with the first and second heat conducting device. Sponge structures are generally characterized by the fact that they have a certain elasticity because of their structure. The heat conducting sponge, as used in some practical examples, is therefore capable of both transferring heat and deforming elastically. The elastic deformability again means that oscillations that are transferred to the second heat conducting device and are transferred by contact also to the heat conducting sponge can be broken down accordingly by the deformation work that occurs. The elasticity of the heat conducting sponge is also sufficient so that the first heat conducting device, to which the sample carrier and/or the heating/cooling element is connected in some practical examples, can be displaced in all spatial directions to the extent required for scanning force microscopy.

In another practical example the coupling device includes a mesh, which is arranged between the first and second heat conducting device. The mesh in some practical examples includes a wire mesh which is barrel-shaped. Between the first and second heat conducting device in this practical example at least one such barrel-shaped wire mesh is arranged. However, there can also be several, for example, four pieces in which the number in principle is arbitrary and depends on the desired heat transfer rate and the dimensioning of both the mesh and the first and/or second heat conducting device. The mesh is elastically deformable so that, as in the aforementioned practical examples, movement of the first heat conducting device relative to the second heat conducting device is made possible in all spatial directions. Movement in the z direction of the first heat conducting device and therefore also the mesh is made possible, for example, in a barrel-shaped mesh by compression or expansion of the barrel-shaped mesh. In some practical examples the individual components of the mesh are not firmly joined to each other but loosely “woven” to each other so that deformation of the mesh occurs by expansion or contraction of the mesh.

In still other practical examples which are similarly fluid-like relative to the aforementioned practical example, which includes a fluid, the coupling device includes a powder, granulate or the like. Fullerenes or nanotubes made of graphite are also used. Mixtures of fluids with solid components, like granulates or powders are also used. Metal spheres (for example, made of copper) can also be used in the practical examples. In principle, any coupling agent that combines with properties of oscillation damping and heat transfer can be combined in the practical examples. The composition and dimensioning of the coupling agent in the practical examples depends on dimensioning of the entire apparatus (or at least the dimensioning of the first and second heat conducting device), the desired heat transfer rate and the desired damping rate.

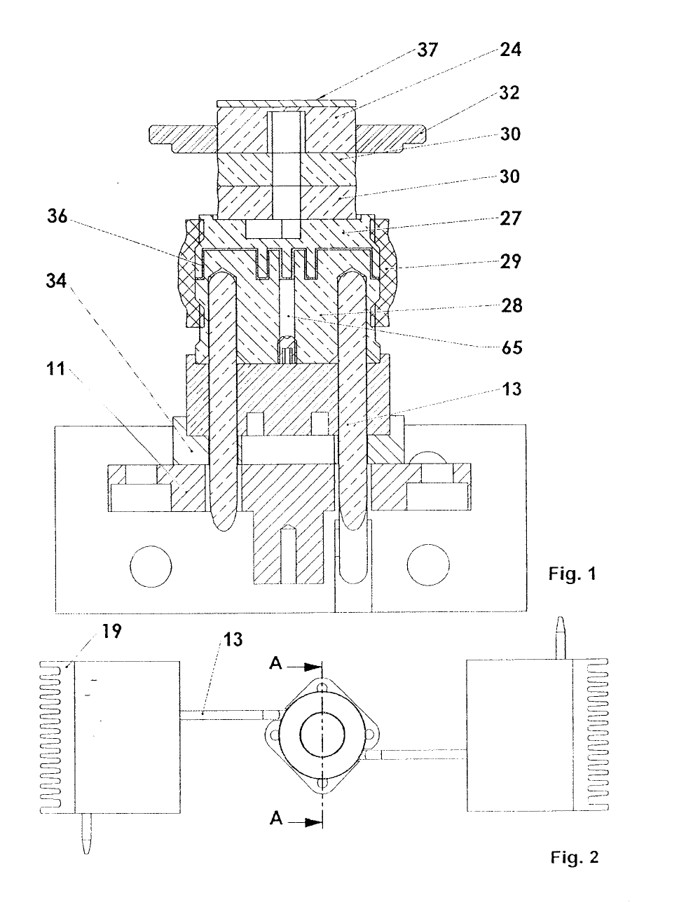

Returning to FIG. 1, this shows a sectional view of a first practical example of the present invention. The sectional view comes about by a vertical section shown by line A-A in FIG. 2. A sample 37 being investigated is situated on a sample carrier 24, which is enclosed by a glass ring 32. The sample carrier 24 is movable by means of a positioning device (not shown) in all directions x, y and z. The spatial directions x and y are perpendicular to each other and parallel to the surface of the sample carrier 24—one spatial direction is therefore perpendicular to the plane of the drawing, whereas the other runs horizontally to the plane of the drawing. The z direction runs perpendicular to the surface of sample carrier 24 and vertically in the plane of the drawing. A heating/cooling element 30 is arranged beneath the sample carrier 24, which is a Peltier element, for example. The subdivision of the heating/cooling element 30 shown in FIG. 1 represents the two layers in which different temperatures develop. For example, during cooling of the upper part of the heat/cooling element 30, heating of the lower part of the heating/cooling element 30 is to be expected, since the heat withdrawn from the upper part is diverted downward. A first heat conducting device 27 is situated beneath the heating/cooling element 30 (referred to subsequently as upper heat conducting device). The upper heat conducting device, which consists of a metal (for example, copper) conducts heat that develops in the lower layer of the heating/cooling element 30 to a coupling device. The coupling device includes a gap here, which is filled with fluid 36. The gap with fluid 36 is, say, 1 mm wide but can be differently dimensioned in other practical examples. The fluid 36 runs in the zig-zag gap, which has the same shape as the bottom of the upper heat conducting device and the upper side of the second heat conducting device 28, which is arranged beneath the upper heat conducting device 27 and is referred to subsequently as lower heat conducting device 28. The gap is zig-zag-shaped in order to provide the largest possible contact surface between the upper heat conducting device 27, fluid 36 and the lower heat conducting device 28. In other practical examples other forms for surface enlargement are implemented, like a lamellar structure, more or fewer folds of the zig-zag structure, cylindrical or conical surface formations, etc. If the sample 37 is moved on the sample carrier 24 in the x-y direction, for example, in the context of a scanning process in order to investigate a sample, the two zig-zag-shaped surfaces of the upper and lower heat conducting devices 27 and 28 are moved opposite each other. Fluid 36, which is found in the gap between the two zig-zag surfaces, is therefore displaced accordingly, the total volume of the gap between the zig-zag surfaces remaining the same during an x-y movement. This is different when the sample carrier is moved up or down, i.e., in the z direction. During a movement in the z direction the volume of the gap between the two zig-zag surfaces of the upper and lower heat conducting devices 27 and 28 is increased or reduced. To equalize these volume changes a fluid reservoir 65 is arranged within the lower heat conducting device 28, from which or in which, depending on the movement of the sample carrier 24 and therefore the other heat conducting device 27, fluid 36 flows. The fluid 36 is held in the gap by a seal 29 which is correspondingly flexible in order to permit the aforementioned movements in the corresponding spatial directions. Heat transfer occurs from the upper heat conducting device 27 via fluid 36 to the lower heat conducting device 28. Two heat conducting device tubes (heat pipes) 13 extend from the lower heat conducting device 28. The heat pipes 13 transport the heat from the lower heat conducting device 28 outward to the corresponding cooling element 19, as shown in FIG. 2. The cooling elements 19 can be actively cooled or give off their heat to the surroundings via cooling fins. The heat pipes 13 contain a fluid that evaporates because of the heat absorbed in the area of the lower heat conducting device and then condenses again in a rear area closer to the cooling element 19. Because of this heat transport is achieved, which gets around any type of mechanical movements, as are produced, for example, during pumping of a cooling liquid. Transfer of mechanical oscillations and/or vibrations to the lower heat conducting device is reduced on this account in contrast to known pump systems. In other practical examples, instead of the heat pipe 13 just discussed, a “conventional” heat fluid pump system with flexible tubes is used. An insulation ring 34 between the heat coupling device and a housing fastening 11 ensures heat and electrical insulation and also dampens mechanical oscillations that can be transferred to the heat coupling device.

FIG. 2 shows a top view of the device depicted in FIG. 1. The sectional axis A shows how the sectional view in FIG. 1 was produced. The heat pipes 13 and the cooling elements 19 are also apparent in FIG. 2. A cooling element 19 is arranged on each side, to which a heat pipe 13 runs. Other practical examples differ in number of heat pipes and number of cooling elements 19. The number is guided according to the demand for heat to be removed, the dimensioning of the corresponding elements of the scanning force microscope and/or the sample carrier 24, the heating/cooling element 30, the upper and lower heat conducting devices 27 and 28, the employed materials, etc. Guiding of the heat pipes 13 is also accomplished according to the corresponding requirements. In some practical examples, instead of cooling element 19, active cooling is used and in still others a combination of active and passive cooling. The heat coupling device in FIG. 2 has an essentially round cross section. In other practical examples the heat conducting device has a rectangular cross section. In still other practical examples the heating/cooling element in the top view (in the z direction) has a rectangular shape, whereas the upper and lower heat conducting devices have a circular shape, etc.

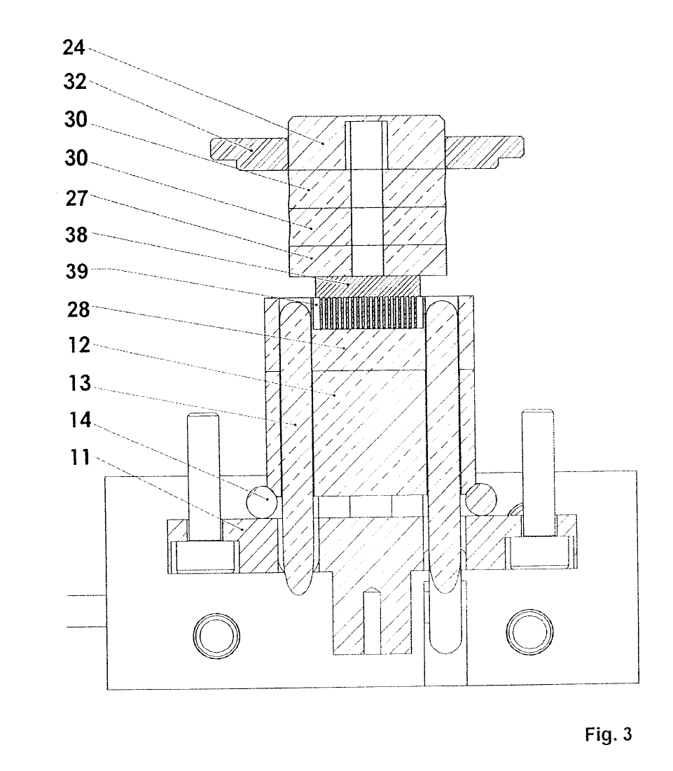

FIG. 3 shows a sectional view of a second practical example of the heat coupling device according to the present invention. The coupling device in FIG. 3 includes a brush structure 38 which is immersed in a coupling agent with a heat conducting fluid 39. The brush structure 38 in some practical examples contains a number of wider bristles made of metal or metal alloy. The diameter of a bristle is different in the practical examples in a range from a few tenths of a millimeter (as occur in wire hairs) to more than a millimeter. The brush structure 38 is arranged on the bottom of the upper heat conducting device 27. In other practical examples the brush structure 38 is molded directly onto the upper heat conducting device 27. The lower heat conducting device 28 has a basin-like structure to accommodate the heat conducting fluid 39. This basin has a diameter greater than the diameter of the brush structure so that during movement of the upper heat conducting device 27 in the x-y direction the bristles of the brush structure 38 strike the wall of the basin for the heat conducting fluid 39. In some practical examples the length of the brush structure and the arrangement of the upper heat conducting device 27 relative to the lower heat conducting device 28 is set up so that even during movement in the z direction the brush structure does not strike the bottom of the basin. In further practical examples, on the other hand, the length of the bristles is chosen so that they strike the wall and/or heat conducting fluid basin in order to additionally increase the heat transfer rate. In still other practical examples a brush structure is also situated on the upper surface of the lower heat conducting device 27 so that the brush structures of the upper 27 and lower heat conducting device 28 mesh with each other and are in contact so that heat transfer can occur. In still other practical examples, in addition to the upper and lower brush structure, a fluid is additionally present between the brush structures, which further increases the heat transfer rate. In all practical examples mentioned in this section transfer of mechanical oscillations is at least dampened based on the combination of brush structure with fluid or brush structure with brush structure (and possibly fluid). In still other practical examples, instead of the brush structure only a wire is arranged between the upper and lower heat conducting device, which is used for heat transfer and is arranged flexibly between the upper and lower heat conducting device. A flexible connection between the wire and the upper and lower heat conducting device in many practical examples includes a joint, whereas in other practical examples the connection is configured so that the wire can deform according to the movement of the upper and lower heat conducting device in the vicinity of the connection site so that it does not break. In still other practical examples the wire is formed so that it has a substructure, like a mesh or several smaller wires. Consequently, in some practical examples wire denotes a higher-order structure that represents a connection structure running between the upper and lower heat conducting device and in some practical examples also has substructures. Heat that develops in the heating/cooling element 30 and is to be diverted downward goes into the upper heat conducting device 28 and from there into the brush structure 38 and therefore into the brushes of brush structure 38. The brush structure 38 is in contact with the heat conducting fluid 39, which, on contact with the brush structure 38, absorbs heat and gives it off to the lower heat conducting device 28. The lower heat conducting structure is in contact with the heat pipes 13, which absorb the heat and convey it outward. The heat pipes 13 correspond to the heat pipes 13 that were described in conjunction with the first practical example.

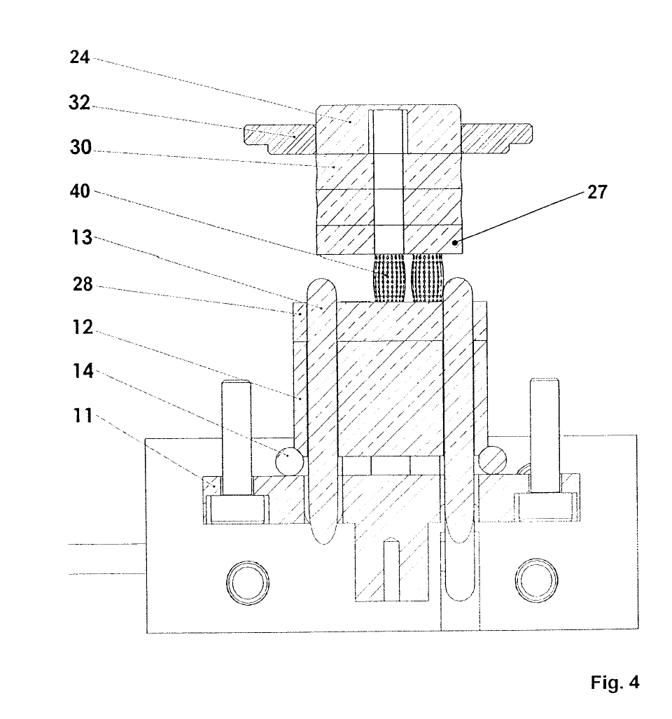

FIG. 4 shows a third practical example of the present invention. A sample carrier 24 is again situated on the top in FIG. 4, beneath which a heating/cooling element 30 is arranged. Heat from the heating/cooling element 30 goes into an upper heat conducting device 27 and from there into a coupling device, which includes a wire mesh 40. Two wire meshes 40 are shown in FIG. 4. In some practical examples only one such wire mesh is present, whereas in other practical examples more than two, for example, four or five wire meshes are present. The number of wire meshes is guided according to the dimensioning of the wire mesh and/or the size of the surface of the upper 27 and/or lower heat conducting device 28 on which the wire mesh 40 is arranged. The two wire meshes 40 shown in FIG. 4 are barrel-shaped and are in contact with their top or bottom with the upper heat conducting device 27 or the lower heat conducting device 28. The barrel-shaped wire mesh has several small openings, which are indicated in FIG. 4 and which form through the mesh structure. In other practical examples the wire mesh is not a mesh in the actual sense but a thin-walled “sheet” with openings that ensure corresponding elasticity. The wire mesh 40 because of the mesh structure and barrel shape is deformable in the z direction, in some practical examples even elastically deformable. During movement of the upper heat conducting device 27 relative to the lower heat conducting device 28 in the z direction the barrel-shaped wire mesh, depending on the direction of movement, is compressed or elongated. The “belly” of the wire mesh 40 increases or reduces its periphery. The wire mesh 40 is dimensioned and arranged with a predetermined “convexity” between the upper and lower heat conducting device 27 and 28 so that separation of the two heat conducting devices to the desired extent can occur before this separation movement is stopped by unduly strong elongation of the wire mesh. In some practical examples, on the other hand, the wire mesh is not firmly connected to the upper and/or lower heat conducting device but is only clamped in between. In these practical examples overstretching of the wire mesh is not possible. During the separation of the two heat conducting devices the wire mesh follows the two heat conducting devices because of its elasticity and does not have to be actively stretched. During a movement of the upper heat conducting device 27 (or lower one, depending on the practical example) in the x-y direction the wire mesh 40, depending on the direction of movement, is deformed in an oblique direction. One side of the wire mesh 40 is compressed as a result, whereas the other is stretched. Heat transport occurs in similar fashion, as already described in conjunction with the first and second practical examples. Heat from the heating/cooling element 30 goes into the upper heat conducting device 27 and from there into the wire mesh 40 through the common contact surface with wire mesh 40. Heat is also given off via wire mesh 40 to the lower heat conducting device 28 via the common contact surface. From there the heat is taken off outward by heat pipes 13. The heat pipes 13 largely correspond to those described above in conjunction with the first practical example.

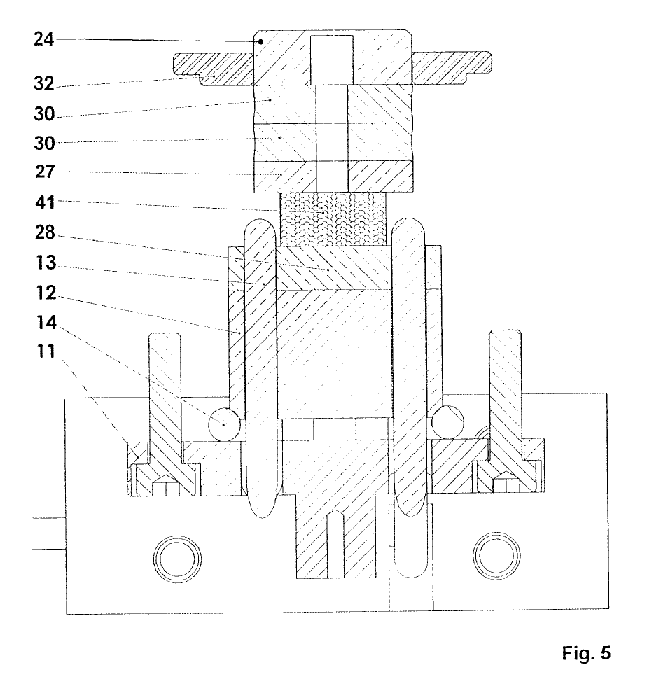

The sectional view according to a fourth practical example of the present invention is shown in FIG. 5. A heating/cooling element 30 is situated beneath the sample carrier 24 and beneath it an upper heat conducting device 27. Between the upper heat conducting device 27 and a lower heat conducting device 28 the coupling device is arranged, which includes a sponge structure 41. The sponge structure 41 is capable of transporting heat from the upper heat conducting device 27 to the lower heat conducting device 28 and is additionally deformable. During a movement of the upper heat conducting device 27 relative to the lower heat conducting device 28 in the z direction, the sponge structure 41 is either compressed or expanded. In some practical examples the sponge structure 41 is clamped between the upper and lower heat conducting device 27 and 28 and is not firmly connected to the heat conducting devices. During separation of the upper and lower heat conducting device 27 and 28 the sponge structure follows the heat conducting devices based on its elasticity, i.e., the sponge structure 41 is pre-compressed between the two heat conducting devices. The sponge structure 41 can have different shapes in the practical examples, like cuboid or cylindrical. On the top and bottom the sponge structure 41 is in surface contact with the upper and lower heat conducting device 27 and 28. The upper and lower heat conducting device 27 and 28, as shown in FIG. 5, have a flat contact surface so that in some practical examples during movement of the upper (and lower) heat conducting device in the x-y direction the contact surfaces slide passed each other and as a result only minimal deformation of the sponge structure 41 occurs in the x-y direction. In other practical examples, on the other hand, the friction force is stronger than the deformation work to be performed on the sponge structure 41 and the sponge structure 41 is deformed accordingly, consistent with the x-y movement of the upper (or lower) heat conducting device 27 (or 28). In some practical examples the sponge structure 41 is elastic so that deformation is essentially reversible. In some practical examples the upper and/or lower heat conducting device 27 or 28 has a needle-like surface on the contact surface to the sponge structure 41 in order to improve the heat transfer rate between the upper and/or lower heat conducting device 27 or 28 and the sponge structure 41. The lower heat conducting device 28 is also in contact with the heat pipes 13 (as described above), which divert the heat outward.

The practical examples described above can be combined with each other. The mentioned coupling devices can also be combined with each other; for example, coupling devices having a rigid structure can be combined with coupling devices also having rigid structures and with those that have non-rigid structures. For example, the aforementioned coupling devices having wire structures, wire meshes, sponge structures, wires, brush structures, comb structures can be combined with each other and/or with coupling devices that do not have rigid structures, for example, fluid, heat conducting fluid, graphite powder, metal spheres, nanotubes, fullerenes, etc.

In the practical examples heat transport is essentially described from a first heat conducting device to a second heat conducting device. It goes without saying that the heat conduction process is not restricted to one direction and the heat coupling device can also be used in order to supply heat to an element, i.e., in order to heat rather than cool a sample and/or heating/cooling element.

1. Heat coupling device for scanning force or atomic force microscopy, comprising:
a first heat conducting device (27),
a second heat conducting device (28) and
a coupling device (36, 38, 39, 40, 41),
in which the first heat conducting device (27) is movable relative to the second heat conducting device (28) and the coupling device (36, 38, 39, 40, 41) is arranged between the first and second heat conducting devices (27, 28) and designed so that it is at least partially deformable fluid-like and/or flexible and heat can be transferred between the first and second heat conducting devices (27,28).

2. Heat coupling device according to claim 1, comprising one or more heating/cooling elements (30).

3. Heat coupling device according to claim 1, comprising a sample carrier (24).

4. Heat coupling device according to claim 2, in which the first heat conducting device (27) is connected to the heating/cooling element (30).

5. Heat coupling device according to claim 3, in which the first heat conducting device (27) can be rigidly coupled to a sample carrier (24) of a scanning force or atomic force microscope and is movable together with it.

6. Heat coupling device according to claim 1, in which the coupling device includes a fluid (36).

7. Heat coupling device according to claim 6, in which the coupling device includes a discharge reservoir (65) for fluid (36) in order to permit movements of the first heat conducting device (27) relative to the second heat conducting device (28) in the z direction.

8. Heat coupling device according to claim 1, in which the coupling device includes a deformable wire mesh (40).

9. Heat coupling device according to claim 1, in which the coupling device includes a brush structure (38).

10. Heat coupling device according to claim 9, in which the brush structure has two brush parts, each of which are coupled to and at least partially in contact with the first heat conducting device (27) and the second heat conducting device (28).

11. Heat coupling device according to claim 1, in which the coupling device includes a sponge structure (41).

12. Heat coupling device according to claim 1, in which the coupling device includes nanotubes made of graphite.

13. Heat coupling device according to claim 1, in which the coupling device includes a mixture of compressible and incompressible components.

14. Heat coupling device according to claim 1, in which the coupling device includes spherical metal pieces.

15. Heat coupling device according to claim 1, in which the coupling device includes fullerenes.

16. Heat coupling device according to claim 1, in which the coupling device has rigid structures (38, 40, 41) and non-rigid structures (36, 39).

17. Heat coupling device according to claim 1, in which the coupling device has compressible (40, 41) and/or incompressible components (36, 38, 39).

18. Heat coupling device according to claim 1, in which heat is diverted from the second heat conducting device (28) by means of at least one heat pipe (13).

19. (canceled)

20. Heating coupling device according to claim 5, wherein said coupling device includes one or more of the following components: a fluid, a deformable wire mesh, a brush structure, a sponge structure, nanotubes made of graphite, compressible and/or non-compressible components, spherical metal pieces, fullerenes, rigid and non-rigid structures, and combinations thereof.
